(19) United States
(12) Patent Application Publication
(10) Pub. No.: US 2024/0284875 A1
(43) Pub. Date: Aug. 29, 2024

(54) kind of pet electronic product with two-way communication

(71) Applicant: Bo LI, Ezhou (CN)

(72) Inventor: Bo LI, Ezhou (CN)

(21) Appl. No.: 18/113,092

(22) Filed: Feb. 23, 2023

(51) Int. Cl. A01K 27/00

(52) U.S. Cl. CPC A01K 27/009

(57) ABSTRACT

The utility model relates to a bidirectional communication pet electronic appliance, which comprises a group of transmitters and receivers, and is characterized in that: The transmitter actively transmits a wireless signal to the receiver to seek a wireless connection with the receiver so as to control the receiver; The receiver is fixedly worn on the pet through a strap and is controlled by the wireless signal sent by the transmitter; The receiver also sends a wireless signal to the transmitter, and the transmitter responds accordingly based on the wireless signal sent by the receiver.

### TECHNICAL FIELD

The invention relates to a pet electronic product, in particular to a pet electronic product capable of two-way communication.

### BACKGROUND TECHNOLOGY

Dog trainers, barkers and electronic fences are common pet electronic products at present. With the progress of technology and the diversification of human needs, a variety of products have been derived. These products generally wear a receiver on the pet. Most functions of pet electronics can be realized through this receiver. This receiver is usually powered by batteries, which have limited power and need to be replaced or charged frequently. However, because the receiver usually needs to be worn on the pet for a long time, and it is inconvenient to charge, users often forget to replace the battery of the receiver or charge the battery, which leads to the failure of the functions of the pet electronic products, resulting in many adverse consequences. Especially for the electronic fence type pet electronics, once the receiver cannot work normally due to insufficient power, the pet is likely to escape over the fence.

### SUMMARY OF THE INVENTION

The invention aims to provide a pet electronic product capable of two-way communication.

According to one aspect of the invention, a pet electronic article capable of two-way communication is provided, which comprises a set of transmitters and receivers,
Wherein, the transmitter actively transmits wireless signals to the receiver to seek to reach a wireless connection with the receiver and then control the receiver;
The receiver is fixed on the pet with a strap and controlled by the wireless signal sent by the transmitter;
The receiver also sends a wireless signal to the transmitter, and the transmitter responds accordingly according to the wireless signal sent by the receiver. For the pet electronics that can communicate in two directions using the above technical scheme, the transmitter can acquire information data including the receiver's own state through establishing two-way communication between the transmitter and the receiver, and can display it through the transmitter. In the use scenario of pet electronics, the receiver is usually worn on the pet and belongs to a mobile part, while the transmitter is generally relatively fixed, so the receiver is powered by a battery and needs to be removed when charging, which is inconvenient. The transmitter does not have the above disadvantages, and charging and operation are relatively convenient. The information data, including the receiver's own state, can be obtained through the transmitter, so that the receiver's power can be known at any time, and the receiver can be prompted to charge when the receiver is out of power, thus the problem that the dog trainer or the electronic fence cannot work due to the receiver's lack of power can be solved intuitively and conveniently.

In some embodiments, the receiver actively sends a wireless signal to the transmitter periodically at a preset time interval, and the wireless signal sent by the receiver includes information about the state of the receiver itself.

In other embodiments, the transmitter sends a wireless signal as a query signal to the receiver, and the receiver sends a wireless signal containing its own state information to the transmitter as a response after receiving the query signal.

Specifically, the information of the state of the receiver itself includes the remaining power of the battery of the receiver.

Further, the transmitter has a display screen, which displays the remaining power of the receiver on the display screen after the transmitter receives the wireless signal sent by the receiver, including the information of its own state.

In other embodiments, the transmitter sends a wireless signal as a query signal to the receiver, and waits for a preset period of time. If the wireless signal returned by the receiver as a response is not received within this period of time, it is judged that the pet wearing the receiver is beyond the control range of the transmitter, and the transmitter performs alarm operation.

Further, the transmitter has a display screen, which displays the remaining power of the receiver on the display screen if the transmitter receives the radio signal returned by the receiver as a response during this time period; If the transmitter does not receive the radio signal returned by the receiver as a response within this time period, the transmitter will conduct alarm operation.

Specifically, the warning operation of the transmitter includes at least one of alarm sound, warning light or vibration prompt.

Specifically, the transmitter also carries out the warning operation through the display screen. During the warning operation, the display screen displays a circular pattern representing the boundary of the transmitter control range. During the warning operation, the display screen displays an icon representing the pet wearing the receiver on the outside of the circular pattern, When the pet wearing the receiver is within the control range of the transmitter, an icon representing the pet wearing the receiver is displayed on the inner side of the circular pattern.

Specifically, after receiving the wireless signal actively sent by the transmitter, the receiver adopts at least one of the following methods to warn or punish the pet, so as to stop the misconduct:

The vibration motor causes the receiver to vibrate which can be perceived by pets;
or send out ultrasonic wave that can be perceived by pets through ultrasonic generator;
or use the electric shock electrode to generate high-voltage micro current to shock the pet's skin.

In some embodiments, the transmitter sends radio signals continuously or periodically. Through the radio signal, the transmitter establishes an area for pets to move freely, and the receiver receives the radio signal. When the radio signal is detected to exist or the radio signal is detected to disappear, it judges the edge of the area where the pet wearing the receiver is close to, At this time, the receiver warns and urges the pet to back away from the edge of the area, so as to ensure that the pet can move freely in the area and will not cross the boundary of the area.

In some embodiments, the transmitter is provided with a transmitting antenna for transmitting radio signals. The transmitter sends radio signals continuously or periodically through the transmitting antenna. Through the radio signals, the transmitter establishes an area for pets to move freely; The receiver receives the radio signal, and when the radio signal is detected to disappear, it judges that the pet wearing the receiver is close to the edge of the area. At this time, the receiver warns and urges the pet to back up to the edge of the area, so as to ensure that the pet can move freely in the area and will not cross the boundary of the area.

### DESCRIPTION OF ATTACHED DRAWINGS

FIG. 1 is the structure diagram of a bidirectional communication pet electronic product according to an embodiment of the invention.

FIG. 2 is an assembly diagram of the receiver shown in FIG. 1.

FIG. 3 shows the circuit structure of the receiver shown in FIG. 3.

FIG. 4 is a schematic diagram of the operation relationship of the transmitter shown in FIG. 1.

### SPECIFIC EMBODIMENTS

The invention will be further described in detail with reference to the accompanying drawings.

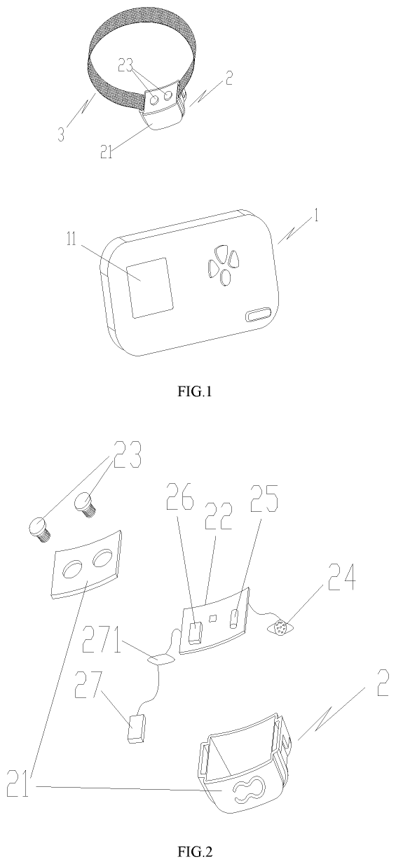

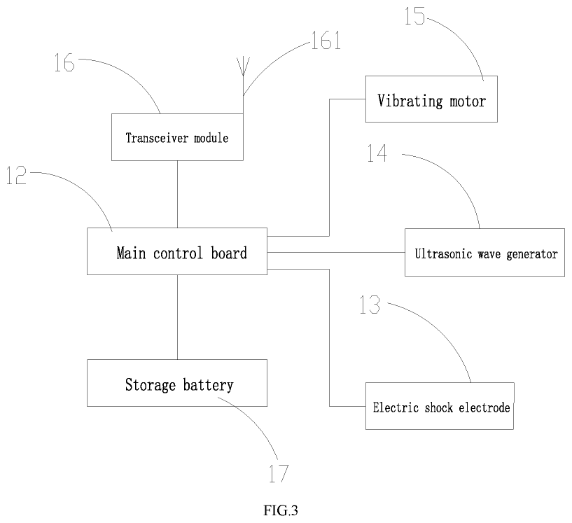

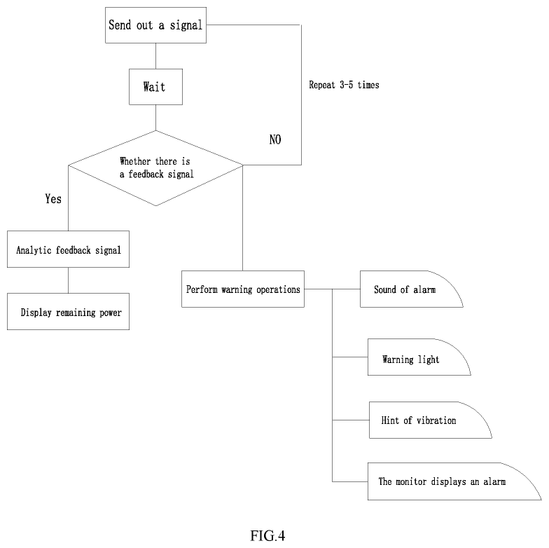

FIGS. 1 to 4 schematically show a bidirectional communication pet electronic article according to an embodiment of the present invention.

As shown in the figure, the device includes a group of transmitters 1 and receivers 2.

Wherein, the transmitter 1 actively transmits a wireless signal to the receiver 2 to seek a wireless connection with the receiver 2 so as to control the receiver 2.

The receiver 2 is fixed on the pet with a strap 3 and controlled by the wireless signal sent by the transmitter 1.

The receiver 2 includes a housing 21 and a main control board 22 arranged inside the housing 21.

The main control board 22 is also connected with the battery 27. The battery 27 is a dry battery or a rechargeable battery, which is used to provide working current to the main control board 22.

A battery management circuit board 271 is also connected in series between the battery 27 and the main control board 22.

The battery management circuit board 271 is used to monitor the power condition of the battery 27 in real time and send relevant data information to the main control board 22.

An electric shock electrode 23 is arranged outside the shell 21, and the electric shock electrode 23 is close to the pet's skin. The shock electrode 23 is connected with the main control board 22 and receives the command of the main control board 22.

In this embodiment, the housing 21 is also internally provided with a vibration motor 25 and an ultrasonic generator 24. The vibration motor 25 and the ultrasonic generator 24 are respectively connected with the main control board 22 and receive commands from the main control board 22.

The main control board 22 is also connected with a transceiver module 26 for receiving the wireless signal of the transmitter 1. The transceiver module 26 has a transceiver antenna 261, which is matched with the transmitter 1 for bidirectional communication.

The receiver 2 sends a wireless signal to the transmitter 1 through the transceiver module 26. The transmitter 1 makes response feedback according to the wireless signal sent by the receiver 2.

In this embodiment, the transmitter 1 sends a wireless signal as a query signal to the receiver 2, and the receiver 2 sends a wireless signal containing its own state information to the transmitter 1 as a response through the transceiver module 26 after receiving the query signal.

The transmitter 1 can periodically and automatically send a wireless signal as a query signal to the receiver 2 after a period of time; It is also possible to manually trigger a wireless signal as an interrogation signal to the receiver 2 by setting a special switch device such as a key on the transmitter 1.

The information of the state of the receiver 2 itself includes the remaining power of the battery of the receiver 2.

In other embodiments, the receiver 2 can also actively send a wireless signal to the transmitter 1 periodically according to a preset time interval. The wireless signal sent by the receiver 2 includes information about the state of the receiver 2 itself.

In this embodiment, the transmitter 1 is provided with a transmission antenna for transmitting radio signals.

By transmitting the radio signal sent by the antenna, transmitter 1 can establish an area for pets to move freely, receiver 2 receives the radio signal, and when the radio signal is detected to disappear, it judges that the pet wearing receiver 2 is close to the edge of the area. At this time, receiver 2 warns and urges the pet to back up until leaving the edge of the area, this ensures that pets can move freely in the area and will not cross the boundary of the area.

Specifically, when the receiver 2 judges the edge of the area where the pet is approaching, it adopts at least one of the following methods to warn or punish the pet, so as to urge the pet to retreat until it leaves the edge of the area:

The vibration motor 24 causes the receiver to vibrate which can be perceived by pets;
or send out ultrasonic wave that can be perceived by pets through ultrasonic generator 25;
or use the electric shock electrode 23 to generate a high-voltage micro current to shock the pet's skin.

After the transmitter 1 sends a wireless signal as a query signal to the receiver 2, it waits for a preset time.

The transmitter 1 has a display screen 11. If the transmitter 1 receives the radio signal returned by the receiver as a response during this period, the remaining power of the receiver 2 is displayed on the display screen 11; If transmitter 1 does not receive the wireless signal returned by receiver 2 as a response within this time period, it is judged that the pet wearing receiver 2 is beyond the control range of transmitter, and transmitter 1 conducts alarm operation.

In actual operation, when the transmitter 1 does not receive the wireless signal returned by the receiver 2 as a reply, it will generally repeatedly send confirmation for 3 to 5 times to avoid the false judgment of the transmitter 1 due to poor signal reception.

The display screen 11 can display the remaining power of receiver 2 in the form of percentage of remaining power, or display the remaining power of receiver 2 through block diagram.

The warning operation of transmitter 1 includes at least one of alarm sound, warning light or vibration prompt.

In other embodiments, transmitter 1 also performs alarm operation through display screen 12. During alarm operation, a circular pattern representing the boundary of transmitter control range is displayed on the display screen, and an icon representing the pet wearing the receiver is displayed on the outside of the circular pattern when the transmitter performs alarm operation, When the pet wearing the receiver is within the control range of the transmitter, an icon representing the pet wearing the receiver is displayed on the inner side of the circular pattern.

Specifically, during the alarm operation, the annular pattern lights up, and the icon on the outside of the annular pattern is always on or flashing, until the pet returns to the control range of the transmitter, the icon on the outside of the annular pattern is off, and the icon on the inside of the annular pattern is always on.

For the pet electronics that can communicate in two directions using the above technical scheme, the transmitter can acquire information data including the receiver's own state through establishing two-way communication between the transmitter and the receiver, and can display it through the transmitter. In the use scenario of pet electronics, the receiver is usually worn on the pet and belongs to a mobile part, while the transmitter is generally relatively fixed, so the receiver is powered by a battery and needs to be removed when charging, which is inconvenient. The transmitter does not have the above disadvantages, and charging and operation are relatively convenient. The information data including the receiver's own state can be obtained through the transmitter, so that the receiver's power can be known at any time, and the receiver can be prompted to charge when the receiver is out of power, which can solve the problem that the dog trainer or electronic fence cannot work because of the receiver's lack of power intuitively and conveniently.

1. The utility model relates to a bidirectional communication pet electronic appliance, which comprises a group of transmitters and receivers, and is characterized in that:
the transmitter actively transmits a wireless signal to the receiver to seek a wireless connection with the receiver so as to control the receiver;
the receiver is fixedly worn on the pet through a strap and is controlled by the wireless signal sent by the transmitter; and
the receiver also sends a wireless signal to the transmitter, and the transmitter responds accordingly based on the wireless signal sent by the receiver.

2. The bidirectional communication pet electronic product according to claim 1, which is characterized in that the receiver periodically sends a wireless signal to the transmitter at a preset time interval, and the wireless signal sent by the receiver includes information about the state of the receiver itself.

3. The bidirectional communication pet electronic article according to claim 1, which is characterized in that the transmitter sends a wireless signal as a query signal to the receiver, and the receiver sends a wireless signal containing its own state information to the transmitter as a response after receiving the query signal.

4. The bidirectional communication pet electronic product according to claim 2, which is characterized in that the information on the state of the receiver itself includes the residual power of the battery of the receiver.

5. The bidirectional communication pet electronic product according to claim 4, which is characterized in that the transmitter has a display screen, and the transmitter displays the residual power of the receiver on the display screen after receiving the wireless signal sent by the receiver, including the information of its own state.

6. The bidirectional communication pet electronic product according to claim 3, which is characterized in that the transmitter sends a wireless signal as a query signal to the receiver and waits for a preset period of time such that if the wireless signal returned by the receiver as a response is not received within this period of time, it is judged that the pet wearing the receiver is beyond the control range of the transmitter, the transmitter performs alarm operation.

7. The bidirectional communication pet electronic product according to claim 6, which is characterized in that the transmitter is provided with a display screen such that if the transmitter receives the wireless signal returned by the receiver as a response within a certain time period, the remaining power of the receiver is displayed on the display screen; and if the transmitter does not receive the radio signal returned by the receiver as a response within this time period, the transmitter will conduct alarm operation.

8. The bidirectional communication pet electronic appliance according to claim 6, which is characterized in that the warning operation of the transmitter includes at least one of alarm sound, warning light or vibration prompt.

9. The bidirectional communication pet electronic product according to claim 7, which is characterized in that the transmitter also performs alarm operation through the display screen such that when the alarm operation is performed, a circular pattern representing the boundary of the transmitter control range is displayed on the display screen, and when the transmitter performs alarm operation, the display screen displays an icon representing a pet wearing the receiver on the outside of the annular pattern, while when the pet wearing the receiver is within the control range of the transmitter, the display screen displays an icon representing a pet wearing the receiver on the inside of the annular pattern.

10. The two-way communication pet electronic product according to claim 1, which is characterized in that the receiver, after receiving the wireless signal actively sent by the transmitter, adopts at least one of the following methods to warn or punish the pet, so as to stop the misconduct:
the vibration motor causes the receiver to vibrate which can be perceived by pets;
or sending out ultrasonic waves that can be perceived by pets through the ultrasonic generator;
or generate high-voltage micro current through the electric shock electrode to shock the pet skin.

11. The bidirectional communication pet electronic product according to claim 3, which is characterized in that the information on the state of the receiver itself includes the residual power of the battery of the receiver.

12. The bidirectional communication pet electronic appliance according to claim 7, which is characterized in that the warning operation of the transmitter includes at least one of alarm sound, warning light or vibration prompt.
